(19) United States
(12) Patent Application Publication
(10) Pub. No.: US 2026/0278553 A1
(43) Pub. Date: Sep. 17, 2026

(54) KNOWLEDGE-BASED PLATFORM FOR EFFICIENT QUERY PROCESSING IN HUMAN CAPITAL MANAGEMENT

(71) Applicant: Paychex of New York, LLC, Rochester, NY (US)

(72) Inventor: Visweshwar Ganesh, Rochester, NY (US)

(73) Assignee: Paychex of New York, LLC, Rochester, NY (US)

(21) Appl. No.: 19/351,600

(22) Filed: Oct. 7, 2025

Related U.S. Application Data
(60) Provisional application No. 63/770,679, filed on Mar. 12, 2025.

(51) Int. Cl. G06Q 10/105; G06F 16/2455

(52) U.S. Cl. CPC G06Q 10/105; G06F 16/2455

(57) ABSTRACT

The present disclosure provides a knowledge-based platform and process for efficient query processing in human capital management. The system leverages artificial intelligence modules to interpret user intent, traverse heterogeneous data sources, and refine responses through human feedback, enabling accurate and context-aware support for workforce-related queries. The platform includes a user interface for receiving and enhancing queries, a vectorized knowledge store, and processors for query rewriting, context retrieval, reinforcement learning from human feedback, and response generation using retrieval-augmented generation. Principal uses include applications in payroll, compliance, human resources, and tax knowledge management.

### CROSS-REFERENCE TO RELATED APPLICATION

The present application relates and claims priority to U.S. Provisional Application Ser. No. 63/770,679, filed, Mar. 12, 2025, the entire disclosure of which is hereby incorporated by reference.

### FIELD OF INVENTION

The present disclosure relates generally to artificial intelligence systems, and more particularly to knowledge-based platforms for efficient query processing in the field of human capital management.

### BACKGROUND

A human capital management (HCM) system is a framework within an organization for processing and interpreting workforce-related data. This framework integrates policies, payroll records, benefits information, and compliance guidelines to support both employees and management decisions. The HCM system is designed to accommodate an expanding array of user queries as organizational complexity grows. Conventional support platforms, however, often struggle to deliver timely, contextually relevant answers when information is scattered across fragmented repositories.

Prior research on automated HCM support tools has focused on rule-based dialog systems, keyword-driven search engines, and static FAQ repositories. While these approaches can address routine inquiries, they frequently lack the adaptability and depth required for evolving workforce scenarios. However, many existing solutions still rely on manual tagging, hierarchical decision trees, or template-based responses that become unwieldy as the scope of HCM knowledge expands and user roles diversify.

Different challenges arise when queries span multiple HCM functional domains, including candidate screening and eligibility evaluation, compensation calculation and payroll validation, benefits enrollment and eligibility verification, and regulatory compliance and risk assessment. Information relevant to these domains is typically stored across disparate databases and document repositories—such as spreadsheets, HR portals, policy manuals, and regulatory archives—each with its own format and indexing scheme. As a result, simple keyword matching often fails to capture the underlying intent or context of a request, leading to responses that are incomplete, outdated, or irrelevant to a user's specific role or organizational context.

Thus, manual intervention is frequently required to interpret and reconcile conflicting sources, contributing to workflow bottlenecks and increased support costs. The variability in user profiles—from new employees to HR administrators—further complicates the task of delivering consistent, personalized guidance. Poorly addressed queries can give rise to misunderstandings, compliance risks, and reduced employee satisfaction. Accordingly, there is a growing demand for more responsive, context-aware HCM support mechanisms.

More sophisticated frameworks have begun to leverage semantic encoding of HCM content by transforming documents and policy text into multidimensional vectors. These platforms enable approximate similarity searches across extensive knowledge repositories, and they incorporate iterative feedback loops wherein subject matter experts review and rate candidate responses to tailor results to specific organizational contexts. However, coordinating semantic retrieval, role-based weighting, and ongoing human feedback remains a challenge in many existing implementations.

There is a need in the art for a streamlined, context-aware query processing platform capable of accurately interpreting user intent, traversing heterogeneous HCM data sources, and continuously refining responses through human feedback.

### SUMMARY OF THE INVENTION

The present disclosure provides a knowledge-based platform for efficient query processing in human capital management. The system leverages artificial intelligence to interpret user intent, traverse heterogeneous data sources, and refine responses through human feedback, enabling accurate and context-aware support for workforce-related queries.

The system includes a user interface for receiving and enhancing user queries through iterative rewriting, a data store for embedded knowledge, and at least one processor configured to rewrite queries to separate intent and data content, retrieve relevant context, apply reinforcement learning from human feedback, generate responses using retrieval-augmented generation, and refine responses using chain-of-thought and tree-of-thought processing. A tool execution component is provided to invoke knowledge tools for additional data gathering, including trainer tools for data retrieval instructions and feedback. The system processes user queries through these components to output a final response.

Trainer tools may include a trainer profile tool, a trainer history tool, and a trainer scoring tool. The user interface may further comprise a prompt enhancer to iteratively refine user queries by soliciting clarifying information. Query rewriting may utilize a fine-tuned large language model to separate user intent from data content. Reinforcement learning from human feedback may involve calculating a boost factor based on trainer persona data, such as job title and department. Retrieval-augmented generation may include performing a vector similarity search against embedded knowledge. Refinement using chain-of-thought and tree-of-thought processing may involve decomposing responses into branching thought sequences and recombining them for enhancement.

The tool execution component may include knowledge tools such as employee information, payroll knowledge, compliance knowledge, HR knowledge, and tax knowledge tools. The trainer profile tool may retrieve trainer persona data to personalize context weighting during reinforcement learning. The data store may comprise a vector database with multidimensional vector embeddings of chunked knowledge and drift metrics for retraining embedding models. A network interface may be included to transmit user queries and return final responses.

A method is provided for delivering knowledge-based responses to human capital management queries, including receiving and enhancing queries, storing embedded knowledge, rewriting queries to separate intent and data content, retrieving relevant context, applying reinforcement learning from human feedback, generating responses using retrieval-augmented generation, refining responses using chain-of-thought and tree-of-thought processing, invoking knowledge and trainer tools, processing queries, and outputting final responses.

The method may further include enhancing queries by soliciting clarifying information, rewriting queries using a fine-tuned large language model, applying reinforcement learning by calculating a boost factor based on trainer persona data, generating responses by performing vector similarity searches, refining responses by decomposing and recombining thought sequences, invoking knowledge tools from a specified group, retrieving trainer persona data to personalize context weighting, utilizing a vector database with drift metrics, and transmitting queries and returning responses via a network interface.

A computer program embodied on a non-transitory computer-readable medium is also provided, comprising instructions which, when executed by at least one processor, cause the processor to perform the method for providing knowledge-based responses to human capital management queries as described above. The computer program may include instructions for receiving and enhancing queries, storing embedded knowledge, rewriting queries to separate intent and data content, retrieving relevant context, applying reinforcement learning from human feedback, generating responses using retrieval-augmented generation, refining responses using chain-of-thought and tree-of-thought processing, invoking knowledge and trainer tools, processing queries, and outputting final responses. The program may further include instructions for soliciting clarifying information, using a fine-tuned large language model, calculating a boost factor, performing vector similarity searches, decomposing and recombining thought sequences, selecting knowledge tools, retrieving trainer persona data, utilizing a vector database with drift metrics, and transmitting and returning responses via a network interface.

### BRIEF DESCRIPTION OF THE DRAWINGS

FIG. 1 is a block diagram showing the architecture of the human capital management knowledge-based system.

FIG. 2 is a block diagram showing the knowledge vectorization process within the system.

FIG. 3A is a block diagram showing the data refinement pipeline from data sources through transformation layers.

FIG. 3B is a block diagram showing the orchestration and transformation of data across multiple processing and embedding layers.

FIG. 3C is a block diagram showing the data transformation pipeline for integrating and indexing knowledge sources.

FIG. 3D is a schematic of the data processing and refinement workflow.

FIG. 3E is a flowchart showing the data processing and refinement workflow from data sources through cleaning, refinement, synthesis, embedding, and vector indexing.

FIG. 4 is a flowchart showing the process for executing a custom search tool to retrieve and refine data.

FIG. 5 is a block diagram showing the AI and data processing architecture, including data sources, orchestration, and search platforms.

FIG. 6 is a block diagram showing the embedding model system for processing and fine-tuning knowledge representations.

FIG. 7 is a flowchart showing the data ingestion process for organizing, refining, and embedding knowledge.

FIG. 8 is a flowchart showing the process of user chat interaction within the system.

FIG. 9 is a flowchart showing a query processing system.

### DETAILED DESCRIPTION

The following detailed description provides an in-depth explanation of the systems, methods, and components related to the present technological development, which pertains to a knowledge-based platform for efficient query processing in the field of human capital management (HCM). This technological development leverages advanced artificial intelligence techniques, including large language models (LLMs), vectorized knowledge representations, and retrieval-augmented generation (RAG), to address the challenges of interpreting user queries, retrieving relevant context, and delivering accurate, context-aware responses. While the embodiments described herein are presented in the context of HCM, the principles and techniques disclosed may be applicable to other domains requiring intelligent query processing and data retrieval.

The examples and embodiments provided in this description are illustrative and not intended to limit the scope of the described subject matter. Certain details, such as well-known hardware configurations, software protocols, or standard data processing techniques, may be omitted for clarity and brevity, as they are readily understood by those skilled in the art. Furthermore, the described subject matter encompasses various modifications, rearrangements, and substitutions of components or processes, provided they fall within the scope of the appended claims. The disclosed embodiments are intended to demonstrate the versatility and adaptability of the described subject matter, and alternative implementations consistent with the underlying principles are also contemplated.

Human capital management (HCM) systems play an important role in managing workforce-related data, encompassing areas such as payroll, benefits, compliance, and employee engagement. However, conventional HCM platforms face significant limitations in addressing the growing complexity of organizational queries. Traditional systems, such as rule-based dialog systems, keyword-driven search engines, and static FAQ repositories, often fail to deliver timely, contextually relevant, and accurate responses. These systems struggle with fragmented data sources, manual tagging, and hierarchical decision trees, which become increasingly unwieldy as the scope of HCM knowledge expands. Furthermore, simple keyword matching techniques frequently fail to capture the intent or context of user queries, particularly when queries span multiple functional domains or require nuanced understanding of regulatory and organizational contexts. This results in incomplete or irrelevant responses, necessitating manual intervention, which in turn leads to workflow inefficiencies, increased support costs, and diminished user satisfaction.

The present system addresses these challenges by introducing a knowledge-based platform that leverages advanced artificial intelligence techniques to deliver efficient, context-aware query processing in HCM. The system employs a combination of fine-tuned large language models (LLMs), vectorized knowledge representations, and retrieval-augmented generation (RAG) to interpret user intent, traverse heterogeneous data sources, and generate accurate, personalized responses. Unlike conventional systems, the platform incorporates a multi-layered approach to query processing, including iterative query rewriting to separate user intent from data content, reinforcement learning from human feedback (RLHF) to refine context weighting, and chain-of-thought and tree-of-thought processing to enhance response quality. These advancements enable the platform to dynamically adapt to diverse user roles, organizational contexts, and evolving regulatory requirements.

At the foundation of the solution is a robust architecture that integrates a user interface for iterative query enhancement, a vector database for storing embedded knowledge, and a tool execution component for invoking specialized knowledge tools. The system processes user queries through a series of advanced algorithms, including vector similarity searches, context retrieval, and iterative response refinement. By leveraging trainer tools and persona-based weighting, the platform ensures that responses are tailored to the specific needs of users, whether they are employees, HR administrators, or compliance officers. Additionally, the system incorporates drift metrics to monitor and retrain embedding models, ensuring the continuous accuracy and relevance of the knowledge base. This comprehensive approach not only streamlines query processing but also enhances user satisfaction, reduces manual intervention, and fosters a more efficient and responsive HCM environment.

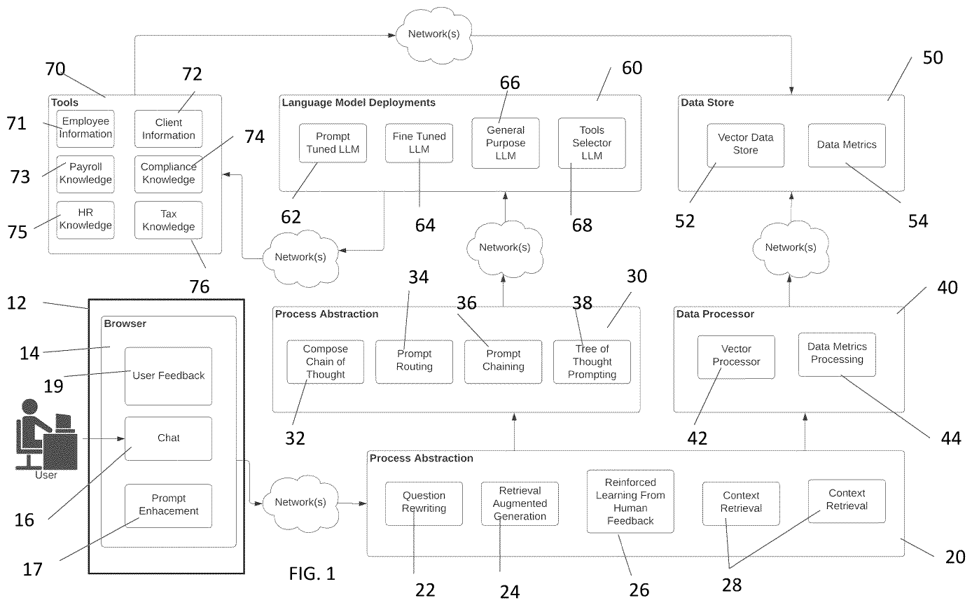

Referring to FIG. 1, a high-level block diagram of the human capital management knowledge-based system 10 is shown, illustrating the architecture and interaction between the components of the system. In some embodiments, the system is designed to process user queries efficiently by leveraging advanced artificial intelligence techniques, including large language models LLMs 60-68, vectorized knowledge representations, and retrieval-augmented generation RAG 24. The diagram highlights the primary functional modules and the data flows that interconnect these modules.

User 12 interacts with the system through a browser 14, which serves as the primary interface. The browser includes a chat interface 16 for submitting queries, a prompt enhancement component 17 for refining user inputs, and a user feedback module 19 for capturing responses and preferences. Accordingly, these elements collectively enable iterative query refinement and ensure that the system adapts to user-specific needs.

FIG. 1 further illustrates that browser 14 communicates with a first process abstraction module 20, which acts as the intermediary between the user interface and the backend systems. Within this module, question rewriting 22 separates user intent from data content, retrieval-augmented generation 24 integrates relevant knowledge into the query context, reinforcement learning from human feedback RLHF 26 refines the system's understanding based on user and trainer feedback, and context retrieval 28 identifies and retrieves pertinent data from various sources. As a result, the first abstraction layer ensures that user inquiries are structured and enriched before deeper processing.

The retrieved data is further processed by a second process abstraction module 30, which applies advanced techniques to enhance the query response. This module 30 includes functions for composing a chain of thought 32, routing prompts 34 to appropriate processing layers, chaining prompts 36 for sequential refinement, and tree-of-thought prompting 38 to explore multiple related ideas in a structured manner. Such multi-stage processing guarantees both breadth and depth in the reasoning applied to each query.

In some embodiments, the system incorporates a data processor 40, which performs vector processing 42 to encode data into high-dimensional vectors and data metrics processing 44 to monitor and optimize the quality of retrieved data. The processed data is stored in a data store 50, which includes a vector data store 52 for storing multidimensional vector embeddings and a data metrics database 54 for tracking performance and drift metrics. This data infrastructure is designed to support both real-time inference and long-term system health monitoring.

Furthermore, language model deployments 60 serve as a foundational component of the system's AI capabilities. This module includes a prompt-tuned LLM 62 for refining user queries, a fine-tuned LLM 64 for domain-specific processing, a general-purpose LLM 66 for broader applications, and a tools selector LLM 68 for routing queries to specialized tools. These models work collaboratively to generate accurate and context-aware responses, thereby ensuring that each user interaction benefits from the appropriate level of domain expertise.

Additionally, the tools module 70 provides specialized interfaces for accessing domain-specific knowledge. The module includes tools for employee information 71, client information 72, payroll knowledge 73, compliance knowledge 74, HR knowledge 75, and tax knowledge 76. When invoked, these tools gather supplemental data to ensure that responses are tailored to the user's query and organizational context. By comparison, if a query does not require external tools, the system may rely solely on outputs from the LLM 60-68 and the vectorized knowledge store.

The architecture remains interconnected through network(s) 80, enabling seamless communication between components. User queries are processed efficiently, leveraging advanced AI techniques to deliver accurate, personalized, and contextually relevant responses across the entire human capital management lifecycle.

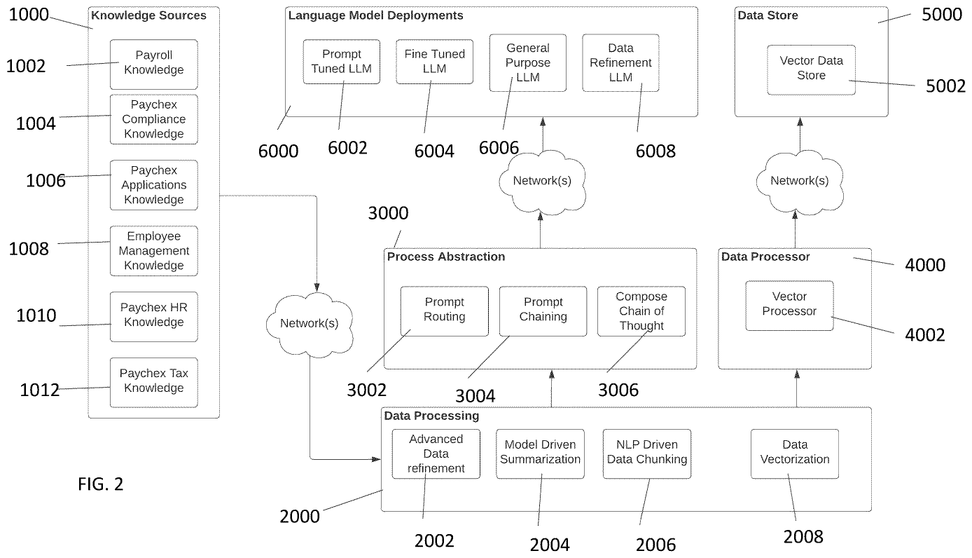

Referring to FIG. 2, the knowledge vectorization process is illustrated within the human capital management system, demonstrating the flow of data from diverse knowledge sources 1000 to vectorized representations and their subsequent integration with language model deployments 6000 for query processing. Accordingly, the schematic captures each stage of data transformation and retrieval in a cohesive framework.

Specifically, the knowledge sources 1000 serve as the foundational repositories of domain-specific information, encompassing payroll knowledge 1002, corporate compliance knowledge 1004, corporate applications knowledge 1006, employee management knowledge 1008, corporate HR knowledge 1010, and corporate tax knowledge 1012. These sources are diverse in nature—comprising proprietary databases, live public sites, and internal organizational repositories—and ensure comprehensive coverage of human capital management domains. As a result, raw data from these sources is transmitted to the data processing module 2000 for refinement and transformation.

In some embodiments, within the data processing module 2000, advanced data refinement 2002 cleanses and prepares the raw data to ensure quality and reliability.

Model-driven summarization 2004 condenses extensive datasets into concise summaries, while NLP-driven data chunking 2006 partitions the data into semantically meaningful units for efficient downstream processing. Thereafter, data vectorization 2008 converts the refined and chunked data into high-dimensional vector representations, thereby enabling semantic encoding of the processed knowledge for subsequent retrieval and analysis.

Subsequently, the vectorized data is transmitted to the data processor 4000, which includes a vector processor 4002. The vector processor 4002 performs operations such as similarity searches and optimization of vector embeddings, thus ensuring that the data are structured for effective retrieval. The processed vectors are then stored in the data store 5000, specifically within the vector data store 5002, which functions as a repository for multidimensional vector embeddings. This storage infrastructure supports both real-time inference and long-term monitoring of data drift metrics.

Additionally, the process abstraction module 3000 acts as an intermediary layer, orchestrating the flow of data and queries between the various components. The module includes prompt routing 3002, which directs incoming queries to the appropriate processing layers; prompt chaining 3004, which performs sequential refinement of responses; and compose chain of thought 3006, which structures responses into logical sequences to enhance coherence and relevance.

Furthermore, language model deployments 6000 integrate the vectorized knowledge with advanced AI capabilities. This module includes a prompt-tuned LLM 6002 for refining user queries, a fine-tuned LLM 6004 for domain-specific processing, a general-purpose LLM 6006 for broader applications, and a data refinement LLM 6008 for summarizing and enhancing retrieved data. Collectively, these models collaborate to generate accurate, context-aware responses tailored to user queries.

The interconnected network(s) facilitate seamless communication among the knowledge sources 1000, data processing module 2000, process abstraction module 3000, data processor 4000, data store 5000, and language model deployments 6000. This architecture enables efficient query processing by utilizing vectorized knowledge representations and advanced AI techniques to provide precise and contextually relevant responses.

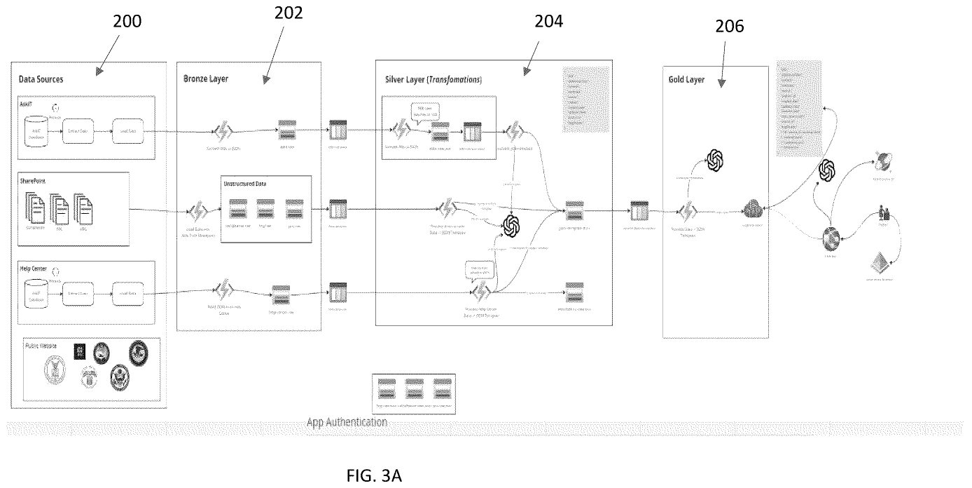

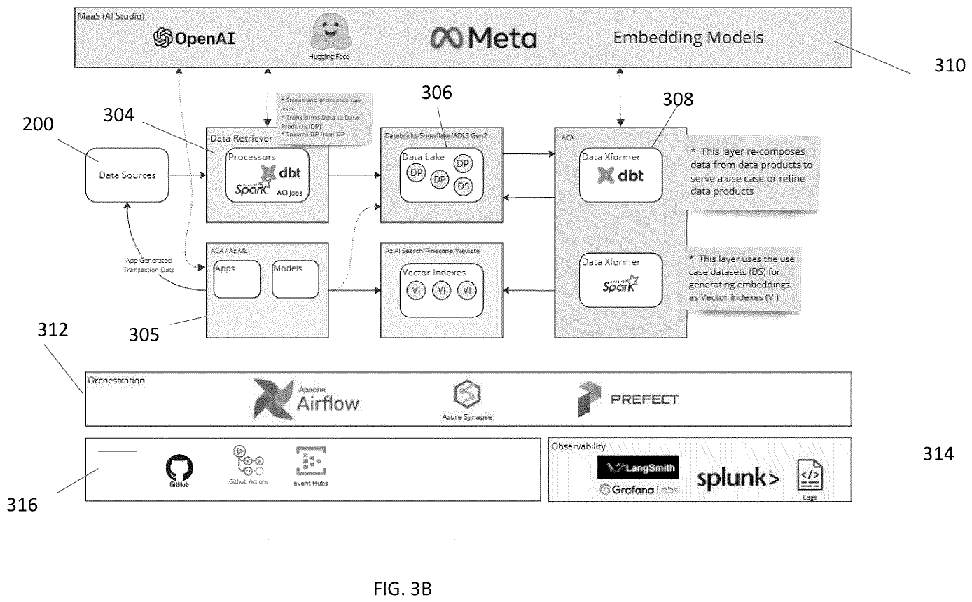

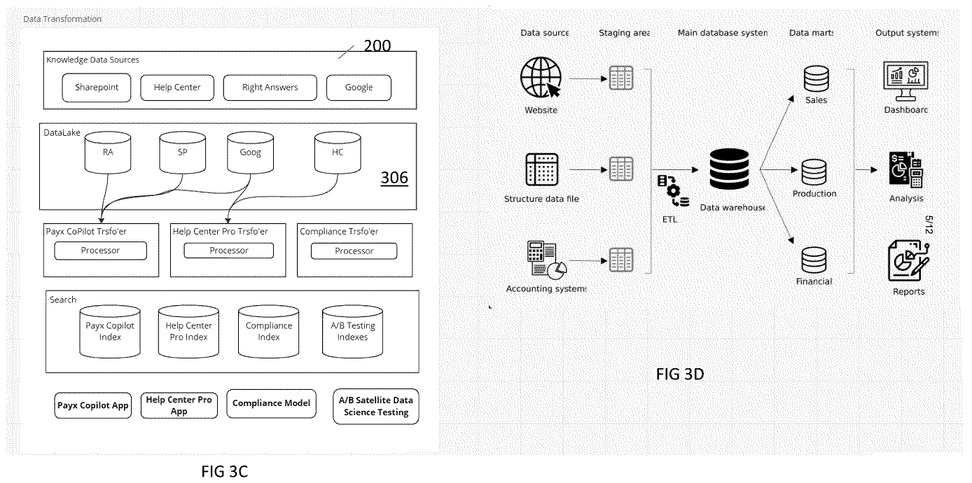

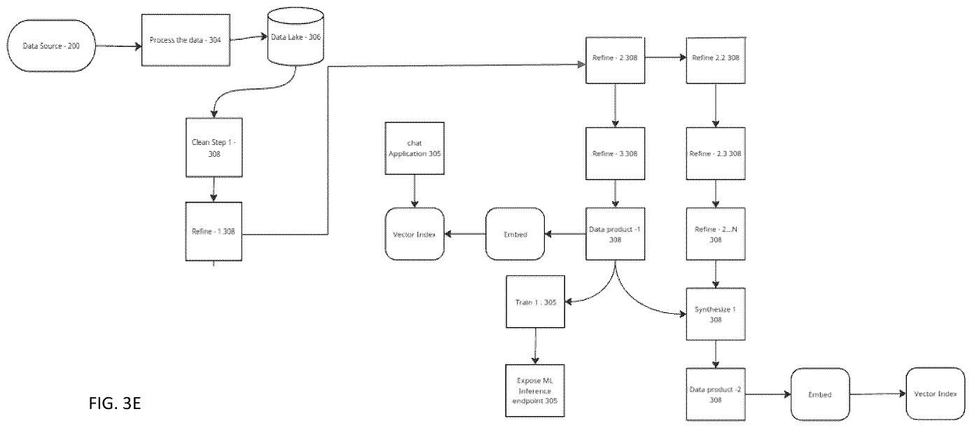

Referring to FIG. 3A are schematics of the data refinement pipeline, illustrating the flow of data from initial sources through successive transformation layers to yield refined, structured outputs. The pipeline is configured to process unstructured and semi-structured data harvested from disparate repositories, ensuring that the incoming information is cleansed, normalized, and prepared for downstream applications, including query processing and retrieval-augmented generation.

There is a need for the pipeline to commence with data sources 200, which constitute the foundational repositories of information. These sources encompass organizational assets such as internal databases, Confluence Data, SharePoint repositories, and help-center tools, in addition to external public websites. The collected data exhibits a broad spectrum of formats—structured, semi-structured, and unstructured—thereby ensuring comprehensive coverage of human capital management HCM domains, for example payroll, compliance, HR, and tax knowledge. By comparison, no single repository alone could deliver the same breadth of subject-matter.

The raw data is first ingested into the bronze layer 202, which serves as the initial staging area. In this layer, data is stored in its native form, preserving the integrity of the original records while enabling basic organization and categorization. The bronze layer 202 operates as the foundational repository for later processing and transformation, and this role is significant for maintaining traceability back to the source systems.

Once the data resides in the bronze layer 202, the data advances to the silver layer 204, where advanced data refinement techniques—such as cleansing, normalization, and enrichment—are applied. Unstructured text, for example, may be segmented into contextually relevant chunks, and metadata is appended to enhance searchability. As a result, the silver layer 204 transforms raw inputs into semantically meaningful representations suitable for integration and analysis, all the while retaining lineage information. The silver layer though represented as one step may in turn go through multiple transformations.

In an embodiment, the final processing stage is embodied by the gold layer 206, which integrates the refined data with AI-driven capabilities, including large language models LLMs and vectorized knowledge representations. As a result, the data is optimized for retrieval-augmented generation and related AI applications. The gold layer 206 also generates data products (FIG. 3E) that in turn could be manifested as a multidimensional vector embeddings that facilitate efficient similarity searches and semantic retrieval across vast HCM datasets.

Throughout each transformation stage, robust app authentication mechanisms are employed to safeguard sensitive information and ensure compliance with organizational and regulatory policies. As a result, the data refinement pipeline depicted in FIG. 3A provides a comprehensive framework for converting heterogeneous sources into actionable insights, thereby enabling secure, efficient, and context-aware query processing within the domain of human capital management.

Referring to FIG. 3B are schematics of the data refinement pipeline within the human capital management knowledge-based platform, illustrating the orchestration and transformation of data across multiple processing and embedding layers. Highlighted is the integration of various components, including data sources, processing tools, data transformation layers, and embedding models—to enable efficient and context-aware query processing. The data refinement pipeline thus provides a modular architecture that supports accurate and tailored responses to user inquiries.

The pipeline begins with the data sources 200, which serve as the foundational repositories of information. As mentioned, these sources encompass diverse datasets such as organizational databases, external repositories, and application-generated transactional data. Accordingly, the data retriever component 304 interfaces with these sources to extract and preprocess raw data. This preprocessing involves cleansing, normalization, and transformation of data into formats suitable for downstream processing. The data retriever utilizes processors such as Apache Airflow, ETL Tools, dbt data build tool and Apache Spark to perform these operations, ensuring that the data is both structured and reliable.

Thereafter, the processed data is stored in a data lake 306, which acts as a centralized repository for managing and organizing the refined datasets. By comparison, the data lake 306 supports multiple use cases by categorizing data into distinct data products DP and datasets DS. This organization, in turn, facilitates efficient retrieval and further processing of data for specific applications.

In some embodiments, the data transformation layer 308—represented by data transformers such as dbt and Spark—plays an important role in re-composing and refining the data. This layer is divided into two primary functions: one focuses on re-composing data products to serve specific use cases or refine existing data products, while the other generates embeddings from use case datasets. As a result, these embeddings are stored as vector indexes, which enable semantic encoding and similarity searches across the knowledge base. For optimal accuracy in Retrieval-Augmented Generation (RAG) processes, it is imperative that the context submitted to the search system is as semantically uniform as possible. This requires a methodical approach to transforming user queries into structured, coherent data forms. By implementing a series of refining processes, as aspect of the invention ensures that queries are accurately interpreted and matched to the appropriate data sources.

The vector indexes are central to the platform's ability to perform retrieval-augmented generation RAG and other advanced AI-driven processes. They enable the system to retrieve contextually relevant information in a streamlined manner, supporting responses to user queries that are precise and aligned with the specific context.

Furthermore, the embedding models 310—including frameworks such as OpenAI, Hugging Face, and Meta—are utilized to generate high-dimensional vector representations of the processed data. As a result, these models enhance the platform's ability to understand and process complex queries by capturing semantic relationships within the data.

With regard to FIG. 3B, when the data is optimized for search, based on the use case the data can be extracted through transformation layer 308 and loaded into the vector databases. Azure AI Search, Pinecone, Weviate are examples of technologies that can be used to expose the data via a vector store. This allows one copy of the data to be kept/stored and also transformed based on the consumer. The data from the vector index can be used to surface information for applications or be used for machine learning.

The pipeline additionally incorporates orchestration tools 312—such as Apache Airflow, Azure Synapse, and Prefect—to manage and automate the flow of data across the various components. These tools ensure that the data refinement processes are executed seamlessly and efficiently, thereby enabling real-time and scalable operations.

Further, observability tools 314, including LangSmith, Grafana Labs, Splunk, and log management systems, are integrated into the pipeline to monitor and analyze system performance. These tools provide insights into the health and efficiency of the data refinement processes, allowing for proactive troubleshooting and optimization.

In some embodiments, version control and event management 316 are facilitated by GitHub, GitHub Actions, and Event Hubs. These components enable collaborative development, continuous integration, and event-driven workflows, ensuring that the system remains adaptable and responsive to evolving requirements.

Overall, FIG. 3B illustrates a comprehensive and modular data refinement pipeline that leverages advanced processing, transformation, and embedding techniques to support the human capital management knowledge-based platform. This architecture ensures that the system can deliver accurate, context-aware, and efficient responses to user queries, addressing the complexities of managing diverse and fragmented data sources.

Referring to FIG. 3C, the diagram presents a higher-level rendition of the system architecture illustrated in FIG. 3B, focusing on the transformation and organization of knowledge data sources within the human capital management platform. The workflow begins with the aggregation of knowledge data sources, such as Sharepoint, Help Center, Right Answers, and Google, which are ingested into a centralized data lake. Within the data lake, repositories such as RA, SP, Goog, and HC are maintained to ensure comprehensive coverage of relevant domains. The data is then processed through specialized transfer processors, including Payx CoPilot Transfer Processor, Help Center Pro Transfer Processor, and Compliance Transfer Processor, which facilitate the transformation and enrichment of the ingested data. Following processing, the data is indexed into dedicated search structures, such as Payx Copilot Index, Help Center Pro Index, Compliance Index, and A/B Testing Indexes, enabling efficient retrieval and semantic searches. The indexed data supports various applications and models, including Payx Copilot App, Help Center Pro App, Compliance Model, and A/B Satellite Data Science Testing, ensuring that the platform delivers accurate, context-aware, and tailored responses to user queries across multiple human capital management domains.

Referring to FIG. 3D, the illustrated workflow provides a higher-level rendering of the system depicted in FIG. 3B, emphasizing the sequential and iterative processes involved in transforming raw data into actionable insights within the human capital management (HCM) knowledge-based platform. The workflow begins with the ingestion of raw, unstructured, or semi-structured data from diverse repositories, including organizational databases, external public websites, and proprietary systems. This data is first staged in a centralized data lake, ensuring traceability and accessibility for subsequent processing. The data then undergoes a series of refinement stages, including cleaning, normalization, and enrichment, to enhance its semantic and contextual relevance. These iterative refinement steps produce distinct data products tailored to specific use cases, such as payroll processing or compliance analysis. Once refined, the data is embedded into high-dimensional vector representations, enabling efficient similarity searches and retrieval-augmented generation (RAG) processes. The workflow further integrates machine learning (ML) models trained on the refined data, which are exposed as inference endpoints to support real-time query handling. At the conclusion of the process, the refined data and trained models are integrated with the user-facing chat application, ensuring that responses to user queries are accurate, context-aware, and personalized. This modular and scalable architecture ensures the system's adaptability to evolving data requirements and user needs.

Referring to FIG. 3E are a further illustration of the data processing and refinement workflows, illustrating the sequential and iterative steps involved in transforming raw data from diverse sources into structured, actionable outputs for the human capital management (HCM) knowledge-based platform. FIG. 3E shows that the workflow is designed to ensure that data is cleansed, enriched, synthesized, and embedded for efficient retrieval and analysis. This flowchart illustrates how data lake 306 can be used and create use case specific applications but, at the same time reusing the data in a useful fashion.

According to an embodiment as illustrated in FIG. 3E, the process begins with a data source 200, which serves as the repository of raw, unstructured, or semi-structured data. As described heretofore, these data repositories may include organizational databases, external data stores, and other heterogeneous sources relevant to HCM domains such as payroll, compliance, HR, and tax knowledge. The raw data is first processed in a data processing module where the data is ingested and organized into a centralized data lake 306. The data lake functions as a staging area for managing and storing raw data in its native form, thereby ensuring traceability and accessibility for subsequent processing steps.

Over time, from the data lake 306 the data undergoes an initial cleaning step 308. This step involves removing inconsistencies, errors, and redundancies to ensure data quality and reliability. Following the cleaning step, the data is subjected to a series of refinement stages 308. These iterative and hierarchical refinement stages—represented by Refine 2.2 308, Refine 2.3 308, through Refine 2.N 308—apply specific transformations to enhance semantic and contextual relevance. As a result, the data progresses through successive layers of enrichment, normalization, and contextualization.

Accordingly, as the data traverses the refinement stages, the data is transformed into distinct data products, such as Data Product 1 308 and Data Product 2 308. These data products are tailored to specific use cases or applications within the HCM platform. For example, Data Product 1 308 may undergo further synthesis in a synthesis step 308 to create a more comprehensive and integrated dataset. By comparison, Data Product 2 308 may be finalized without additional synthesis for targeted retrieval scenarios.

Furthermore, once the data products are finalized they are embedded using an embedding process. This embedding step involves converting the refined data into high-dimensional vector representations, which capture semantic relationships and contextual nuances within the data. The embeddings are then stored in a vector index, thereby enabling efficient similarity searches and retrieval-augmented generation RAG processes.

In addition, the workflow incorporates a training module 305, where machine learning ML models are trained using the refined data. These models are subsequently exposed as ML inference endpoints 305, allowing the system to leverage trained models for real-time data processing and query handling. The integration of ML inference endpoints ensures that the platform remains adaptive and responsive to evolving user queries and organizational requirements.

The refined data and trained models are subsequently integrated with the chat application 305, which serves as the user-facing interface for query processing. The chat application interacts with the vector index and ML inference endpoints to deliver accurate, context-aware, and personalized responses to user queries. This comprehensive workflow ensures that the data processing pipeline is modular, scalable, and optimized for the complexities of managing diverse and fragmented data sources within the HCM domain.

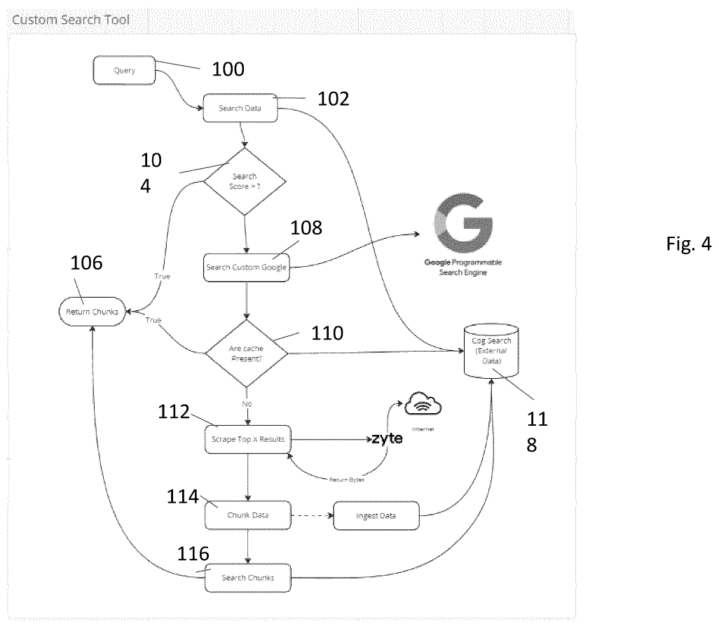

Referring to FIG. 4 are steps of a flowchart illustrating a process for executing a custom search tool to retrieve and refine data. The flowchart delineates decision points and operations designed to optimize retrieval of relevant information by leveraging multiple data sources and iterative refinement techniques. The process is configured to ensure that a user query is processed in a manner that yields accurate and contextually relevant results.

The process begins with a query 100, which represents the user's input or question. Accordingly, this query is directed to a search data operation 102, where the system initiates a search across available data sources. The results of this initial search are evaluated based on a search score 104, which determines the relevance and quality of the retrieved data. If the search score meets or exceeds a predefined threshold, the system proceeds to return chunks 106, which are semantically meaningful segments of data that directly address the query.

If the search score does not meet the threshold, the system transitions to a custom search operation 108. This step involves utilizing a programmable search engine—such as Google Custom Search—to expand the scope of the search and identify additional data sources that may contain relevant information. The system then evaluates whether cache is present 110 for the retrieved results. In cases where cached data is available, the cached data is employed to streamline the process and avoid redundant operations.

In some embodiments, where no cache is present, the system proceeds to scrape the top X (variable that can be customized) results 112 from the search engine. This scraping operation retrieves the most relevant links and associated metadata, which are then subjected to further processing. Thereafter, the scraped data is chunked 114 into smaller, manageable segments to facilitate efficient analysis and retrieval. These chunks are subsequently searched 116 to identify the most pertinent portions of the data.

The process also incorporates an external cognitive search operation 118, which interfaces with external data repositories to enhance the breadth and depth of the search. This step ensures access to a diverse range of data sources, including proprietary databases, live public sites, and other organizational repositories. By comparison, the integration of external data further enriches the context and accuracy of the final response.

Throughout the process, the system employs iterative refinement techniques to optimize the quality of the retrieved data. By leveraging a combination of internal and external data sources, caching mechanisms, and advanced search algorithms, the custom search tool is designed to address user queries with precision and contextual relevance. This approach proves to be particularly beneficial in complex domains—such as human capital management—where queries often require nuanced understanding and integration of diverse data sets.

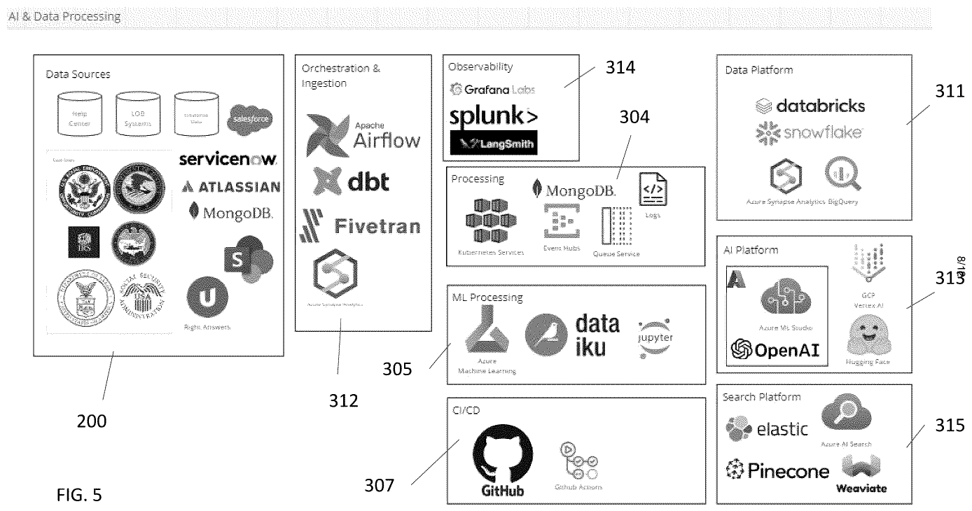

Referring to FIG. 5 are diagrams of the AI and data processing architecture, illustrating the interaction among various components that collectively enable efficient query processing and data refinement within the human capital management knowledge-based platform. The architecture is organized into modular units, each responsible for specific functions ranging from data ingestion through AI-driven response generation.

Referring to module 200 of FIG. 5 are the data sources, which represent the foundational repositories of information utilized by the system. These sources include help center tools, line-of-business systems, enterprise data repositories, and external platforms such as Salesforce, ServiceNow, Atlassian, and MongoDB. Additionally, the system integrates data from government sources such as . gov websites and organizational tools such as SharePoint and Right Answers. These diverse data sources collectively support broad coverage of human capital management domains, including payroll, compliance, HR, and tax knowledge.

Referring to module 202 of FIG. 5 is the orchestration and ingestion module, which facilitates the seamless integration and organization of data from the various sources. Tools such as Apache Airflow, dbt, and Fivetran are employed to automate workflows, manage dependencies, and ingest data into the system. As a result, raw data is efficiently collected and prepared for downstream processing.

Referring to module 314 of FIG. 5 is the observability module, which incorporates tools such as Grafana Labs, Splunk, and LangSmith to monitor system performance and provide insights into the health and efficiency of the data processing pipeline. Accordingly, these tools enable proactive troubleshooting and optimization, ensuring the reliability and scalability of the system.

Referring to module 304 of FIG. 5 is the processing module, which is responsible for transforming and refining the ingested data. Components such as MongoDB, Kubernetes services, and queue services facilitate data storage, processing, and management. Logs are also utilized to track system operations and ensure traceability. By comparison, the processing module's design emphasizes modularity to accommodate evolving data requirements.

Referring to module 305 of FIG. 5 is the machine learning processing module, which leverages platforms such as Dataiku, Azure Machine Learning, and Jupyter to develop, train, and deploy machine learning models. These models are significant in analyzing data, generating insights, and enhancing the system's ability to deliver accurate and context-aware responses.

Referring to module 307 of FIG. 5 is the continuous integration and continuous delivery module, which incorporates tools such as GitHub and GitHub Actions to enable collaborative development, version control, and automated deployment of system updates. This approach ensures that the system remains adaptable and responsive to evolving requirements.

Referring to modules 311, 313, and 315 of FIG. 5 are the data platform, AI platform, and search platform, respectively. The data platform 311 provides a centralized repository for managing and organizing refined datasets, utilizing tools such as Databricks, Snowflake, and Azure Synapse Analytics to consolidate data, perform analytics, and support efficient retrieval and storage. The AI platform 313 integrates advanced artificial intelligence capabilities—including frameworks such as Azure ML Studio, OpenAI, Hugging Face, and Google Cloud Vertex AI—to perform complex query processing, generate human-like responses, and refine outputs using techniques such as retrieval-augmented generation. The search platform 315 facilitates efficient data retrieval and semantic searches across the knowledge base, employing Elastic, Azure AI Search, Pinecone, and Weaviate to perform vector similarity searches and optimize the relevance of retrieved information. Collectively, these platforms form a robust architecture that supports the human capital management knowledge-based platform by leveraging advanced AI techniques, machine learning models, and modular data processing tools to deliver accurate, personalized, and context-aware responses to user queries.

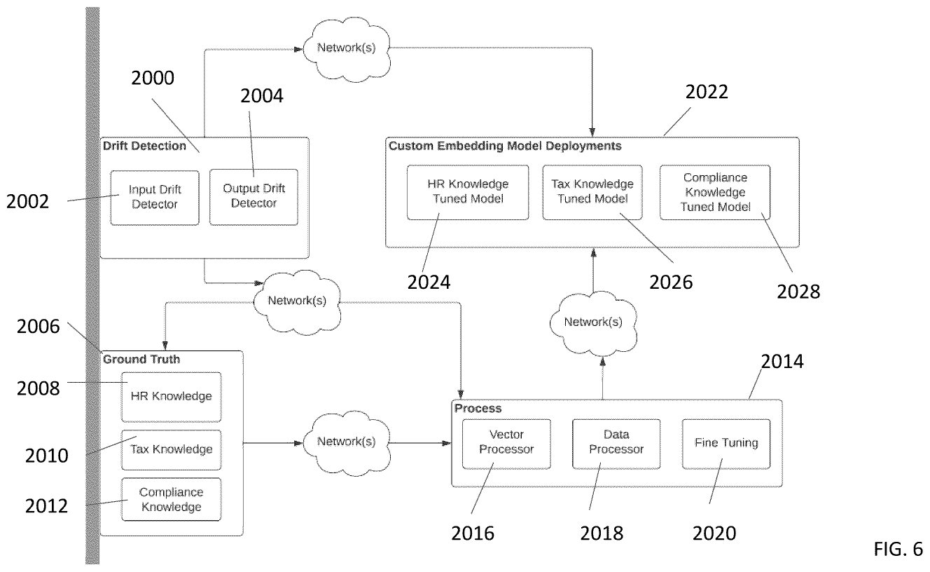

Referring to FIG. 6 is a schematic of the embedding model system for processing and fine-tuning knowledge representations within the human capital management knowledge-based platform. Over time, this system has been designed to ensure the accuracy, relevance, and adaptability of the knowledge base by leveraging drift detection mechanisms, domain-specific embedding models, and advanced processing components. Accordingly, the architecture depicted in FIG. 6 illustrates how each module interconnects to maintain the integrity of the embedding models and to adapt continuously to evolving data and user requirements.

In some embodiments, the system begins with a drift detection module 2000, which comprises an input drift detector 2002 and an output drift detector 2004. The input drift detector 2002 monitors changes in the incoming data, identifying new content that significantly deviates from the existing dataset such as average detection delay and false-alarm rate for n=3. By comparison, the output drift detector 2004 evaluates the system's responses, tracking user feedback to detect material deviations in the quality or relevance of generated outputs. These drift detection mechanisms play an important role in maintaining the fidelity of the embedding models and ensuring that the platform adapts dynamically to both data drift and feedback drift.

FIG. 6 further illustrates the ground truth knowledge repository 2006 forming the foundational layer of the system, encompassing HR knowledge 2008, tax knowledge 2010, and compliance knowledge 2012. The ground truth data 2006 is transmitted through network(s) to the processing components, where the data undergoes transformation and refinement. Specifically, the processing module 2014 includes a vector processor 2016, a data processor 2018, and a fine-tuning component 2020. The vector processor 2016 encodes the ground truth data into high-dimensional vector representations, enabling semantic encoding and similarity searches. The data processor performs additional transformations, such as normalization and optimization, to enhance the quality and usability of the vectorized data. The fine-tuning component adjusts the embedding models to align with the specific characteristics of the ground truth data, thereby ensuring that each model is optimized for its respective domain.

FIG. 6 further illustrate custom embedding model deployments 2022 with separate tuned models for HR knowledge 2024, tax knowledge 2026, and compliance knowledge 2028, each fine-tuned to capture the distinct semantic relationships and contextual nuances within its domain. The network(s) facilitate seamless communication between the drift detection module, the ground truth repository, the processing components, and the embedding model deployments. This interconnected architecture enables the system to dynamically update the embedding models based on detected drifts, refined ground truth data, and processing outputs. As a result, the platform evolves over time to provide accurate, context-aware responses tailored to the specific needs of the human capital management domain.

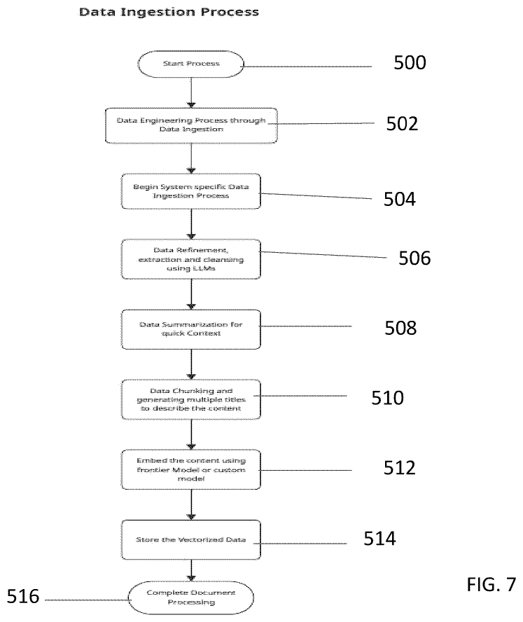

Referring to FIG. 7 is a flowchart illustrating the data ingestion process within the human capital management knowledge-based platform. FIG. 7 depicts the initial scanning of sources 3000, which involves identifying and accessing diverse repositories of human capital management HCM data. These repositories include, but are not limited to, internal databases, external public websites, organizational tools, and proprietary systems. The scanning step ensures broad coverage of HCM domains such as payroll, compliance, HR, and tax knowledge.

FIG. 7 further shows the orchestration of ingested data through dedicated ingestion tools. Accordingly, frameworks such as Apache Airflow or Fivetran are employed to automate workflows, manage dependencies, move data and prepare data for synchronization. The orchestration step integrates and organizes data from multiple sources, ensuring that the ingestion process is both efficient and scalable. The orchestration provides robust workflow dispersity upon sequestration and surface complexation of incoming data streams.

Subsequently, synchronization of the data ingestion process is initiated, where the ingested data is aligned and consolidated across various systems. The synchronization step guarantees consistent formatting and readiness for downstream refinement, thereby minimizing discrepancies and redundancies. The linear ranges, quantified from comparative synchronization metrics, demonstrate the ability of this platform to maintain data consistency over time.

Following synchronization, the data undergoes refinement using quality-assurance tools. This involves cleansing, normalization, and enrichment of the data to ensure accuracy and reliability. For example, unstructured text is segmented into contextually relevant chunks, and metadata is appended to enhance searchability.

Changes in data quality metrics upon refinement are associated with improved downstream retrieval performance and reduced error rates.

Further, FIG. 7 illustrates the connection of refined data to analytical systems. Once connected, the platform performs advanced processing tasks—such as summarization, chunking, and vectorization—which play a significant role in transforming raw data into actionable insights. The refined data is then chunked and vectorized using natural language processing NLP techniques. Data chunking divides content into semantically meaningful units, while vectorization converts these units into high-dimensional vector representations. These representations enable semantic encoding and facilitate efficient similarity searches across the knowledge base.

FIG. 7 also shows the embedding of content using semantic search and vector search methodologies. Embedding involves creating multidimensional vector embeddings that capture semantic relationships within the data. These embeddings are stored in a vector database, ensuring data accessibility for real-time inference and retrieval. The calibration curves of embedding performance indicate detection limits and linear ranges of semantic similarity measures.

Next, the structured data is stored in the system's data repository. This storage infrastructure supports long-term monitoring of data drift metrics and ensures that the data remains organized and retrievable for future applications. The repository's monitoring capabilities demonstrate sensitivity to drift over a concentration range of operational parameters.

The process flow of FIG. 7 concludes with business processing, where the ingested and refined data is utilized to support various HCM functions. This may involve generating responses to user queries, performing analytics, or enabling decision-making processes within the organization. The business processing step ensures that the data ingestion pipeline contributes to the overall efficiency and responsiveness of the HCM system. As a result, the platform delivers a cohesive, comprehensive solution for knowledge management in human capital domains.

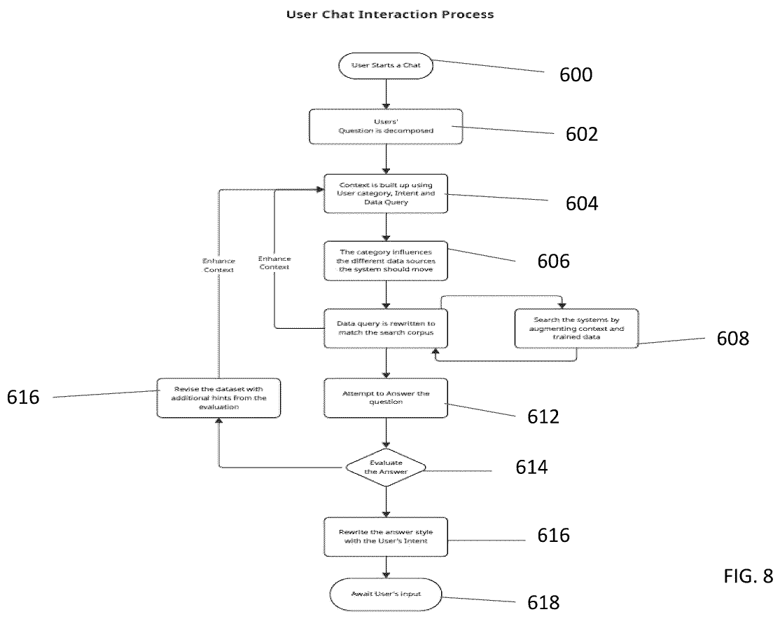

More generally, regarding FIGS. 7 and 8, while the LLM is not illustrated in the diagrams for the purpose of simplicity, one or more LLMs are in the mix in each step of the process. The data-ingestion process flow depicted in FIG. 7 begins with scanning sources 500 to identify relevant data inputs. The data enrichment process 502 is then initiated through a data pipeline to enhance the raw data. Following this, synchronization begins with the data integration process 504, ensuring that disparate data sources are aligned. The data is subsequently transformed using rules 506 to standardize and structure the information for further processing. A connection to the data system 508 is established to facilitate integration, after which the data undergoes cleaning and validation 510 to remove inconsistencies. The enriched data content is further augmented using external data sources 512. The structured data is then stored 514 in a repository, and the process concludes with the completion of the data ingestion process 516.

The data-enrichment and data-transformation sub-stages within FIG. 7 include the data enrichment process 502, which enhances the raw data by adding relevant metadata or supplementary information. The data transformation stage 506 applies predefined rules to standardize and format the data, ensuring compatibility with downstream systems. The data cleaning and validation stage 510 removes inconsistencies, errors, and redundancies, ensuring the integrity of the dataset. At the conclusion of these processes, the enriched data content 512 is augmented by incorporating external data sources, further improving the quality and relevance of the data.

The synchronization, integration, storage, and completion milestones of FIG. 7 begin with the data integration process 504, which aligns and merges data from various sources into a unified format. The data system connection 508 ensures seamless integration by linking the processed data to the appropriate systems. The structured data is then stored 514 in a repository, making the repository readily accessible for subsequent use. The data ingestion process is finalized with the completion stage 516, signifying the readiness of the data for operational or analytical purposes.

The user-chat interaction workflow illustrated in FIG. 8 begins when the user starts a chat 600. The user's question is interpreted 602 to extract intent and relevant details. Context is built up 604 using the user's profile and question to create a search query. The category 606 influences the search query and determines the data sources to be utilized. The system then searches 608 the identified data sources by employing ranking rules to prioritize results. The dataset with the most relevant information is retrieved 610, and the process continues to aggregate and deliver an answer to the user 612.

The query interpretation, context building, category influence, ranked searching, and dataset retrieval phases within FIG. 8 begin with interpreting the user's question 602 to understand the intent and extract actionable elements. Context is developed 604 by combining the user's profile and the question to formulate a refined search query. The category 606 significantly influences the shaping of the search query and the selection of appropriate data sources. The system searches 608 these sources using ranking rules to ensure that relevant results are prioritized. At the conclusion of this process, the dataset with the greatest relevance is retrieved 610 for further processing.

The answer aggregation, evaluation, style revision, and loopback waiting stages in FIG. 8 begin with aggregating the answer 612 from the retrieved dataset to provide a coherent response. The aggregated answer is then evaluated 614 to ensure accuracy and relevance. Based on the evaluation, the answer style is revised 616 to align with user expectations and preferences. The process concludes with awaiting the user's input 618, allowing for further interaction or clarification as needed.

In terms of technical effects, the user interface, configured to receive and enhance user queries through iterative rewriting, ensures that the system can refine ambiguous or incomplete queries into structured and semantically clear forms. This improves the accuracy of downstream processing by aligning the query with the system's data retrieval and processing capabilities, reducing the likelihood of irrelevant or incomplete responses.

The data store, which stores embedded knowledge in the form of multidimensional vector embeddings, enables efficient and contextually relevant retrieval of information. By leveraging vectorized representations, the system can perform similarity searches that go beyond simple keyword matching, allowing the system to capture the semantic intent of the query and retrieve the most pertinent data.

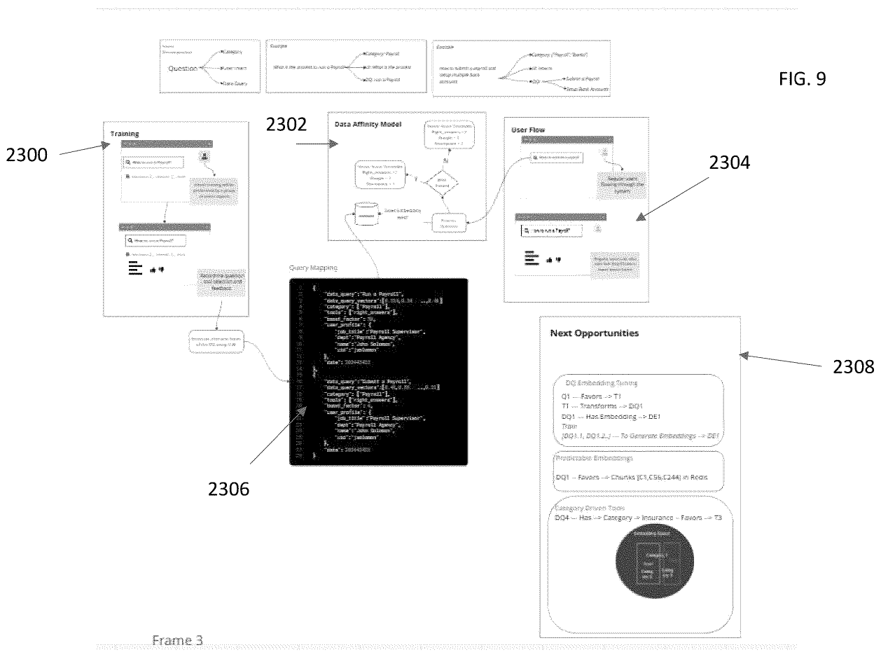

As illustrated in FIG. 9, the processor's ability to rewrite the user query to separate intent from data content ensures that the system can distinguish between the user's informational needs and the specific data required to fulfill those needs. This separation enhances the precision of the query processing pipeline, particularly in complex domains like human capital management, where queries often involve nuanced intent.

More specifically, Referring to FIG. 9 is a flowchart of a query processing system that illustrates the sequential and interconnected components involved in processing user queries to generate contextually relevant and precise responses. In some embodiments, the system is designed to leverage advanced AI techniques, including reinforcement learning from human feedback RLHF, data affinity modeling, and embedding tuning, to optimize the query processing pipeline. The schematic representation of FIG. 9 emphasizes both modularization and data flow, thereby ensuring that each stage contributes to the overall accuracy and adaptability of the system.

FIG. 9 corresponds to the Training 2300 component, which plays a foundational role in refining the system's ability to process queries. Trainers utilize specialized annotation tools to provide feedback and guidance on query handling, including query labeling, category specification, and corrective adjustments. This iterative training process contributes to improving the system's capacity to distinguish between user intent and underlying data content, while also fostering adaptability to diverse organizational requirements and user roles.

FIG. 9 further illustrates the Data Affinity Model 2302, a significant element that assesses the relationship between the user query and available data sources. This model calculates affinity scores using contextual cues and metadata to determine the data sets most suited for retrieval. In line with this, decision-making logic within this element manages queries across multiple repositories, facilitating smooth integration of foundational and product-specific information. The affinity-based selection process thereby aligns the retrieved data with the user's intent and the particular needs of each query.

FIG. 9 also illustrates the User Flow 2304 component, which captures the user's query and guides the query through the processing pipeline. This component focuses on query rewriting, whereby the system decomposes the original input into constituent elements—namely intent and data query DQ—and maps the rewritten query to the appropriate data sources. The rewritten queries are subsequently translated into structured formats, such as JSON-like data structures, encapsulating intent, category, and relevant metadata to enable efficient downstream processing.

Also shown in FIG. 9 are the Query Mapping 2306 and Next Opportunities 2308 components. The Query Mapping 2306 component translates rewritten queries into structured data constructs that align with target data source schemas, thereby facilitating accurate information retrieval. The Next Opportunities 2308 component highlights potential areas for further optimization, including embedding tuning—whereby embeddings used for query representation are incrementally adjusted to enhance retrieval accuracy—and the integration of category-driven tools to prioritize domain-specific data sets. These enhancements demonstrate the system's ongoing capacity to deliver accurate, context-aware, and personalized responses, addressing the challenges of managing complex queries in dynamic organizational environments.

The retrieval of context relevant to the rewritten query from the data store ensures that the system can dynamically adapt to the specific needs of the user. By accessing heterogeneous data sources and integrating relevant context, the system provides responses that are both accurate and tailored to the user's organizational role and query intent.

The application of reinforcement learning from human feedback (RLHF) to weight the retrieved context introduces a mechanism for continuous improvement. By incorporating feedback from trainers and users, the system can dynamically adjust the weighting of retrieved data, ensuring that responses remain aligned with evolving organizational requirements and user preferences.

The RLHF training must account for the shared regulations across different products while recognizing the distinct needs of each product-specific user group. For example, assume an organization's product involves collaboration among its product, service, and development teams. Questions and answers concerning payroll issues will inherently differ from those for other payroll products reflecting unique workflows and considerations. So, when addressing a user query regarding an error code during payroll submission, in this example, the response must be tailored to the user's context, what product they are using and their role within the organization. Despite these differentiations, underlying considerations such as compliance and regulatory information must remain universally applicable across the organization's ecosystem.

Further, to effectively customize responses, trainers must adeptly navigate a corpus of questions by leveraging targeted data sets within the organization. This data retrieval workflow maybe strategically skewed according to the trainer's persona, which includes their job title, department, and other influential parameters. These personas govern the trajectory of the workflow, imparting a personalized touch to the user experience. While this workflow journey can be projected, it is not rigid. Introducing a “boost factor” can enhance a workflow based on the user's profile. For instance, a supervisor may achieve a higher boost factor than a senior trainer, considering their proficiency in that particular area.

Also, the process of training the trainers is crucial, as they can significantly guide the workflow direction. A trainer's competency should not be confined to their title. They may exhibit mastery over their primary product suite and demonstrate exceptional proficiency in completely different domains. Such diversity in expertise allows individuals in a primary area like payroll achieve greater boost factors in areas like tax laws, surpassing even seasoned service representatives.

By adopting a nuanced RLHF strategy tailored for an organization's diverse products, the organization can foster an efficient, regulatory-compliant, and personalized user experience. As referenced above, trainers play a pivotal role in this system, ensuring the workflows are accurately aligned with users' needs and broader organizational requirements, thus contributing to optimal productivity and customer satisfaction.

The use of retrieval-augmented generation (RAG) to generate responses allows the system to combine the generative capabilities of large language models with the precision of retrieved knowledge. This hybrid approach ensures that responses are both contextually rich and grounded in accurate, domain-specific information.

Upon receiving a user question, the system embarks on a dual-stage process involving rewriting and extraction. This begins with decomposing the query to separate relevant categories, user intent, and the necessary data query (DQ). A fine-tuned language model adept at content separation performs this extraction, ensuring clarity and precision in understanding the user's needs.

For seamlessly guiding the data query to the correct data system, the query may undergo several iterative rewriting processes against other purpose tuned models. These iterations are tailored to align with the specific system capabilities and requirements, ensuring the questions are posed in a manner congruent with the data source's structure. For instance, obtaining tax implication information may necessitate querying across multiple data sources. Some data sources might be foundational, containing core information, while others are application-oriented, focused on practical applications.

The manner in which queries are framed depends largely on the nature of the data source. When seeking data from foundational sources, product names are typically omitted to focus on universal information. Conversely, product names become critical when queries are directed at product-specific data sources, ensuring the question resonates with the specific content the system possesses.

Furthermore, the refinement of responses using chain-of-thought and tree-of-thought processing introduces a structured reasoning mechanism. By decomposing complex queries into branching thought sequences and recombining them, the system can generate responses that are logically coherent and comprehensive, addressing multifaceted user queries effectively.

The tool execution component, which invokes knowledge tools to gather additional data, ensures that the system can access specialized data sources as needed. This modular approach allows the system to integrate domain-specific tools, such as payroll or compliance knowledge tools, to enhance the depth and relevance of the system's responses.

The inclusion of trainer tools within the tool execution component provides a mechanism for human oversight and guidance. By enabling trainers to provide data retrieval instructions and feedback, the system can leverage domain expertise to refine operations, ensuring that responses are both accurate and contextually appropriate.

The overall architecture of the system, which processes user queries through the processor and tool execution component to output a final response, ensures a seamless and efficient workflow. By integrating advanced AI techniques, such as RLHF, RAG, and vectorized knowledge retrieval, the system delivers timely, accurate, and context-aware responses, addressing the challenges of managing complex human capital management queries.

What is claimed is:

1. A system for providing knowledge-based responses to queries related to human capital management, comprising:
a user interface configured to receive a user query and enhance the query through iterative rewriting;
a data store configured to store embedded knowledge;
at least one processor operatively coupled to the user interface and the data store, the processor configured to:
rewrite the user query to separate intent and data content;
retrieve context relevant to the rewritten query from the data store;
apply reinforcement learning from human feedback to weight the retrieved context;
generate a response using retrieval-augmented generation;
refine the response using chain of thought and tree of thought processing;
a tool execution component configured to invoke one or more knowledge tools to gather additional data, the tool execution component further comprising trainer tools configured to provide data retrieval instructions and feedback;
wherein the system is configured to process the user query through the processor and the tool execution component to output a final response.

2. The system of claim 1, wherein the trainer tools comprises a trainer profile tool, a trainer history tool, and a trainer scoring tool.

3. The system of claim 1, wherein the user interface further comprises:
a prompt enhancer configured to iteratively refine the user query by soliciting clarifying information from the user.

4. The system of claim 1, wherein rewriting the user query comprises:
using a fine-tuned large language model to separate user intent from data content.

5. The system of claim 1, wherein applying reinforcement learning from human feedback comprises:
calculating a boost factor based on trainer persona data, the trainer persona data including trainer job title and trainer department.

6. The system of claim 1, wherein generating the response using retrieval-augmented generation comprises:
retrieving relevant context by performing a vector similarity search against the embedded knowledge stored in the data store.

7. The system of claim 1, wherein refining the response using chain-of-thought and tree-of-thought processing comprises:
decomposing the response into branching thought sequences; and
recombining the sequences to produce an enhanced response.

8. The system of claim 1, wherein the tool execution component comprises:
at least one knowledge tool selected from the group consisting of an employee information tool, a payroll knowledge tool, a compliance knowledge tool, an HR knowledge tool, and a tax knowledge tool.

9. The system of claim 1, wherein the trainer profile tool is configured to:
retrieve trainer persona data from the data store to personalize the weighting of retrieved context during reinforcement learning from human feedback.

10. The system of claim 1, wherein the data store comprises:
a vector database storing multidimensional vector embeddings of chunked knowledge; and
drift metrics for triggering retraining of embedding models.

11. The system of claim 1, further comprising:
a network interface operatively coupled to the user interface and the at least one processor to transmit the user query to the processor and return the final response to the user.

12. A method for providing knowledge-based responses to queries related to human capital management, the method comprising:
receiving, via a user interface, a user query and enhancing the query through iterative rewriting;
storing embedded knowledge in a data store;
rewriting the user query, using at least one processor operatively coupled to the user interface and the data store, to separate intent and data content;
retrieving context relevant to the rewritten query from the data store;
applying reinforcement learning from human feedback to weight the retrieved context;
generating a response using retrieval-augmented generation;
refining the response using chain of thought and tree of thought processing;
invoking, via a tool execution component, one or more knowledge tools to gather additional data, the tool execution component further comprising:
trainer tools configured to provide data retrieval instructions and feedback;
processing the user query through the processor and the tool execution component; and
outputting a final response.

13. The method of claim 12, wherein enhancing the query through iterative rewriting comprises:
soliciting clarifying information from the user to refine the user query.

14. The method of claim 12, wherein rewriting the user query comprises:
using a fine-tuned large language model to separate user intent from data content.

15. The method of claim 12, wherein applying reinforcement learning from human feedback comprises:
calculating a boost factor based on trainer persona data, the trainer persona data including trainer job title and trainer department.

16. The method of claim 12, wherein generating a response using retrieval-augmented generation comprises:
retrieving relevant context by performing a vector similarity search against the embedded knowledge stored in the data store.

17. The method of claim 12, wherein refining the response using chain of thought and tree of thought processing comprises:
decomposing the response into branching thought sequences; and
recombining the sequences to produce an enhanced response.

18. The method of claim 12, wherein invoking one or more knowledge tools comprises:
selecting at least one knowledge tool from the group consisting of an employee information tool, a payroll knowledge tool, a compliance knowledge tool, an HR knowledge tool, and a tax knowledge tool.

19. The method of claim 12, wherein the trainer tools are configured to:
retrieve trainer persona data from the data store to personalize the weighting of retrieved context during reinforcement learning from human feedback.

20. The method of claim 12, wherein the data store comprises:
a vector database storing multidimensional vector embeddings of chunked knowledge; and
drift metrics for triggering retraining of embedding models.

21. The method of claim 12, further comprising:
transmitting the user query to the processor and returning the final response to the user via a network interface operatively coupled to the user interface and the at least one processor.

22. A computer program embodied on a non-transitory computer-readable medium, the computer program comprising instructions which, when executed by at least one processor, cause the processor to perform a method for providing knowledge-based responses to queries related to human capital management, the method comprising:
a) receiving, via a user interface, a user query and enhancing the query through iterative rewriting;
b) storing embedded knowledge in a data store;
c) rewriting the user query to separate intent and data content;
retrieving context relevant to the rewritten query from the data store;
d) applying reinforcement learning from human feedback to weight the retrieved context;
e) generating a response using retrieval-augmented generation;
refining the response using chain of thought and tree of thought processing;
f) invoking, via a tool execution component, one or more knowledge tools to gather additional data, the tool execution component further comprising:
trainer tools configured to provide data retrieval instructions and feedback;
g) processing the user query through the processor and the tool execution component; and
h) outputting a final response.

23. The computer program of claim 22, wherein receiving, via a user interface, a user query and enhancing the query through iterative rewriting comprises:
soliciting clarifying information from the user to refine the user query.

24. The computer program of claim 22, wherein rewriting the user query to separate intent and data content comprises:
using a fine-tuned large language model to separate user intent from data content.

25. The computer program of claim 22, wherein applying reinforcement learning from human feedback to weight the retrieved context comprises:
calculating a boost factor based on trainer persona data, the trainer persona data including trainer job title and trainer department.

26. The computer program of claim 22, wherein generating a response using retrieval-augmented generation comprises:
retrieving relevant context by performing a vector similarity search against the embedded knowledge stored in the data store.

27. The computer program of claim 22, wherein refining the response using chain of thought and tree of thought processing comprises:
decomposing the response into branching thought sequences; and
recombining the sequences to produce an enhanced response.

28. The computer program of claim 22, wherein invoking, via a tool execution component, one or more knowledge tools to gather additional data comprises:
selecting at least one knowledge tool from the group consisting of an employee information tool, a payroll knowledge tool, a compliance knowledge tool, an HR knowledge tool, and a tax knowledge tool.

29. The computer program of claim 22, wherein the trainer tools are configured to:
retrieve trainer persona data from the data store to personalize the weighting of retrieved context during reinforcement learning from human feedback.

30. The computer program of claim 22, wherein the data store comprises:
a vector database storing multidimensional vector embeddings of chunked knowledge; and
drift metrics for triggering retraining of embedding models.

31. The computer program of claim 22, further comprising instructions which, when executed by the at least one processor, cause the processor to:
transmit the user query to the processor and return the final response to the user via a network interface operatively coupled to the user interface and the at least one processor.
